(19) United States
(12) Patent Application Publication
(10) Pub. No.: US 2016/0366091 A1
(43) Pub. Date: Dec. 15, 2016

(54) EMAIL THREAD SEQUENCE MANAGEMENT

(71) Applicant: International Business Machines Corporation, Armonk, NY (US)

(72) Inventors: Timothy J. Baldwin, Southampton (GB); Barry N. Dow, Gosport (GB); Andrew Johnson, Winchester (GB); Peter J. Johnson, Chandlers Ford (GB); Fenglian Xu, Chandlers Ford (GB)

(21) Appl. No.: 14/734,062

(22) Filed: Jun. 9, 2015

(51) Int. Cl. H04L 12/58

(52) U.S. Cl. CPC H04L 51/34; H04L 51/06; H04L 51/16

(57) ABSTRACT

Email thread sequence management includes monitoring outgoing email messages of an email server and creating a metadata record for an email thread of multiple email messages relating to a subject, where the metadata record includes an entry of metadata for each email message in the email thread, and where each entry has a sequence number. A sequence number is added to an outgoing email message according to the sequence number of the email message in the metadata record for the email thread. The method further includes receiving a request for a missing email message in the email thread from a recipient, checking the metadata record for email thread for the missing email message for the recipient, and retrieving the missing email message from a different recipient or the sender of the email message for forwarding to the requesting recipient.

### BACKGROUND

The present disclosure relates to email thread management, and more specifically, to email thread sequence management and retrieving missing emails in an email thread.

Email conversations or threads may start with a list of initial recipients. Responses to the initial email or subsequent emails in the same thread may miss out some of the initial recipients. An email thread is a chain of emails relating to the same subject, usually with the same subject heading. It may occur that some of the initial recipients for a few emails during long email chains are forgotten or missed. An individual may desire to be assured of seeing each email in an email thread in a long history conversation.

### SUMMARY

Embodiments of the present disclosure provide for a method, system, and computer program product for email thread management.

One embodiment is directed toward a method for email thread sequence management, including: monitoring outgoing email messages of an email server; creating a metadata record for an email thread of multiple email messages relating to a subject, where the metadata record includes an entry of metadata for each email message in the email thread, and where each entry has a sequence number; adding a sequence number to an outgoing email message according to the sequence number of the email message in the metadata record for the email thread; receiving a request for a missing email message in an email thread from a recipient; checking the metadata record for email thread for the missing email message for the recipient; and retrieving the missing email message from a different recipient or the sender of the email message for forwarding to the requesting recipient.

Another embodiment is directed toward a system for email thread sequence management including a sequence management system integrated with an email server, where the sequence management system includes: an outgoing email monitoring component for monitoring outgoing email messages of an email server; a metadata updating component for creating a metadata record for an email thread of multiple email messages relating to a subject, wherein the metadata record includes an entry of metadata for each email message in the email thread, and wherein each entry has a sequence number; a sequence component for adding a sequence number to an outgoing email message according to the sequence number of the email message in the metadata record for the email thread; a request receiving component for receiving a request for a missing email message in an email thread from a recipient; and an email obtaining component for checking the metadata record for email thread for the missing email message for the recipient retrieving the missing email message from a different recipient or the sender of the email message for forwarding to the requesting recipient.

Another embodiment is directed toward a computer program product for email thread sequence management, the computer program product including a computer readable storage medium having program instructions embodied therewith, the program instructions executable by a processor to cause the processor to: monitor outgoing email messages of an email server; create a metadata record for an email thread of multiple email messages relating to a subject, wherein the metadata record includes an entry of metadata for each email message in the email thread, and where each entry has a sequence number; add a sequence number to an outgoing email message according to the sequence number of the email message in the metadata record for the email thread; receive a request for a missing email message in an email thread from a recipient; check the metadata record for email thread for the missing email message for the recipient; and retrieve the missing email message from a different recipient or the sender of the email message for forwarding to the requesting recipient.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a schematic diagram, which shows example messages and stored metadata, according to various embodiments.

FIG. 2 depicts a flow diagram for a sequence management system, according to various embodiments.

FIG. 3 depicts a flow diagram, which illustrates a method carried out by a sequence management system, according to various embodiments.

FIG. 4 depicts a block diagram shows an email server and email client, according to various embodiments.

FIG. 5 depicts an exemplary system, as described herein, according to various embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to email thread management, and more specifically, to email thread sequence management and retrieving missing emails in an email thread.

Email conversations or threads may start with a list of initial recipients. Responses to the initial email or subsequent emails in the same thread may miss out some of the initial recipients. An email thread is a chain of emails relating to the same subject usually with the same subject heading. It is very common to miss out some of the initial recipients for a few emails during long email chains. It is a problem for an individual to be ensured of seeing each email in an email thread in a long conversation history.

An email sent to an individual's mailbox on their mail server and an individual can only receive an email when their email address is on the mailto list. Generally, there is no way to store the entire history of emails to all recipients based on a subject. Therefore, there is a need in the art to address the aforementioned problems. According to various embodiments, the described method and system create a master metadata version of individual emails, based on a subject.

One solution is to find out which email is missing and ask someone on the list to forward the missing email to you. However, a possible drawback is that there may be no clear indication as to who has been missed out and for which particular email in the entire email chain. One problem to be addressed is how to get the missed out emails without significantly changing existing email technologies.

Generally, a sequence management system allows participants in an email thread to find any missing emails based on a particular subject. The sequence management system stores metadata when an email is sent out. The metadata is in the form of: an email sequence order number, send date/time, subject, and associated parties including sender and recipients.

The sequence management system provides a separate system that can be integrated into any existing email system. The sequence management system may be connected to an email server and when an email is sent out by the email server, the metadata about the email is collected and stored in a metadata table. A sequence number is generated and added to the outgoing email message. A sequence number may be generated and added according to the order in which an email or message is received, or when the email or message is processed, or added to a table, index, etc.

The sequence management system enables tracing of a sequence number of an email thread based on a subject and being able to identify the missed out emails. It provides a capability to query missed out emails from a person on the mail list who has received the missing email. This provides a capability to send the missed out emails to a requester without persisting the entire history of email messages.

A new email event occurs when an email message is sent to a list of recipients and an entry record is created in a metadata table of the sequence management system. The record includes the metadata of: the sequence number in the thread, the send date/time, the subject, and the parties including the sender and the recipients.

When a reply is sent to a list of recipients, the system adds another entry to the metadata record, this data entry may have different parties in that it may have missed out a recipient and/or may have added new recipients, according to various embodiments.

This email communications may occur several times in a thread. If one of the recipients is dropped out by someone and later on someone else adds the missing out recipient back again, he/she may need some history data to make some inputs or decisions to the conversation.

A recipient may query the sequence management system for missing email messages. The recipient may know the missing sequence number if she has received a later message with a non-sequential number. Alternatively, the recipient may make a query without knowing if a message is missing, for example, a last message in a sequence. The email system can also be implemented to have a default behavior to check and query all missing out history emails on behalf of this person.

According to various embodiments, the sequence management system may then check who has the missing email message and queries the email message from that recipient's mail box, and sends it to the requester.

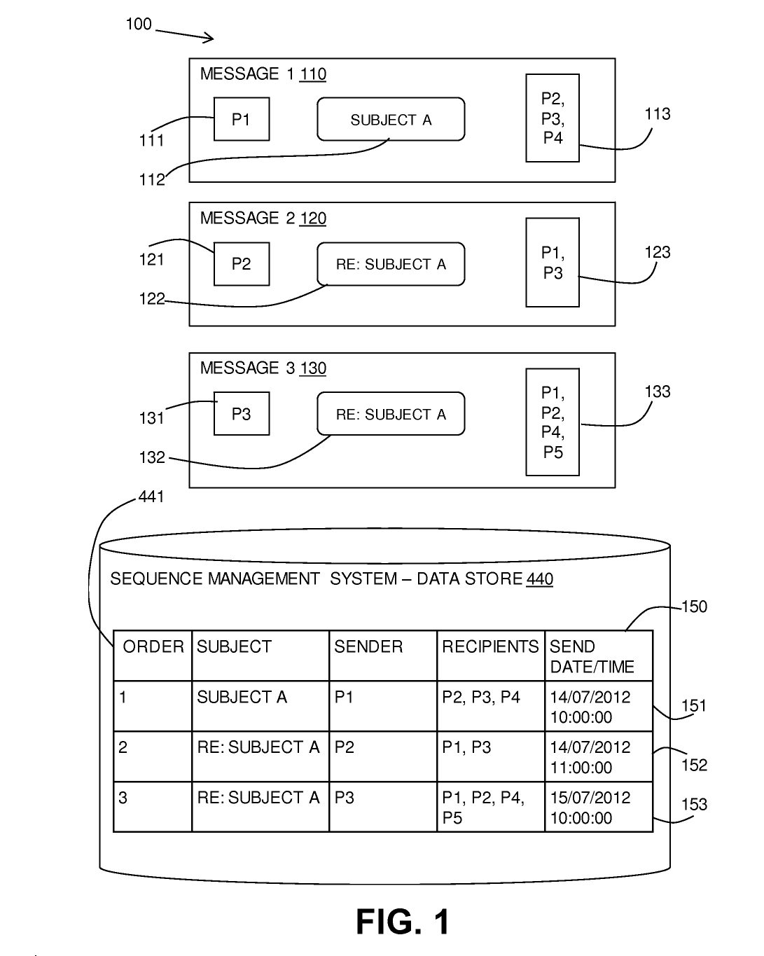

FIG. 1 depicts a schematic diagram 100, which shows example messages and stored metadata, according to various embodiments.

A sequence of email messages 110, 120, 130 is illustrated. Message 1 110 is sent by person P1 111 with subject “Subject A” 112 to recipients 113 P2, P3, P4. Message 2 120 is sent by person P2 121 and replies to message 1 110 with subject “Re: Subject A” 122. Message 2 120 replies to recipients 123 P1 and P3, but deletes P4. This may be intentional or by accident. Message 3 130 is sent by person P3 131 and replies to message 2 120 with subject “Re: Subject A” 132. Message 3 130 replies to all previous recipients 133 P1, P2, P3, P4 and adds a new recipient P5.

A metadata table 441 is created and stored at a data store 440 of the described sequence management system, according to various embodiments. The metadata table 441 has record 150 created when a first message in a thread is sent. A first entry 151 in the record 150 is created with a first sequence number “1.” The first entry 151 includes the subject, the sender, the recipients, and the send date/time.

Subsequent email messages sent in the same thread with corresponding subject have additional entries 152, 153 added to the record 150. Each entry has an incremented sequence number. The sequence number is added to the outgoing email message that is sent from the email server.

Recipient P4 will receive message 3 130 with sequence number “3” and will realize that he has not received message 2 120 in the thread, according to various embodiments. He or she can then request a copy of message 2 120 from the sequence management system, which identifies recipient P1 or P3 who have received message 2 120, and retrieves a copy of the message from their inbox for forwarding to recipient P4.

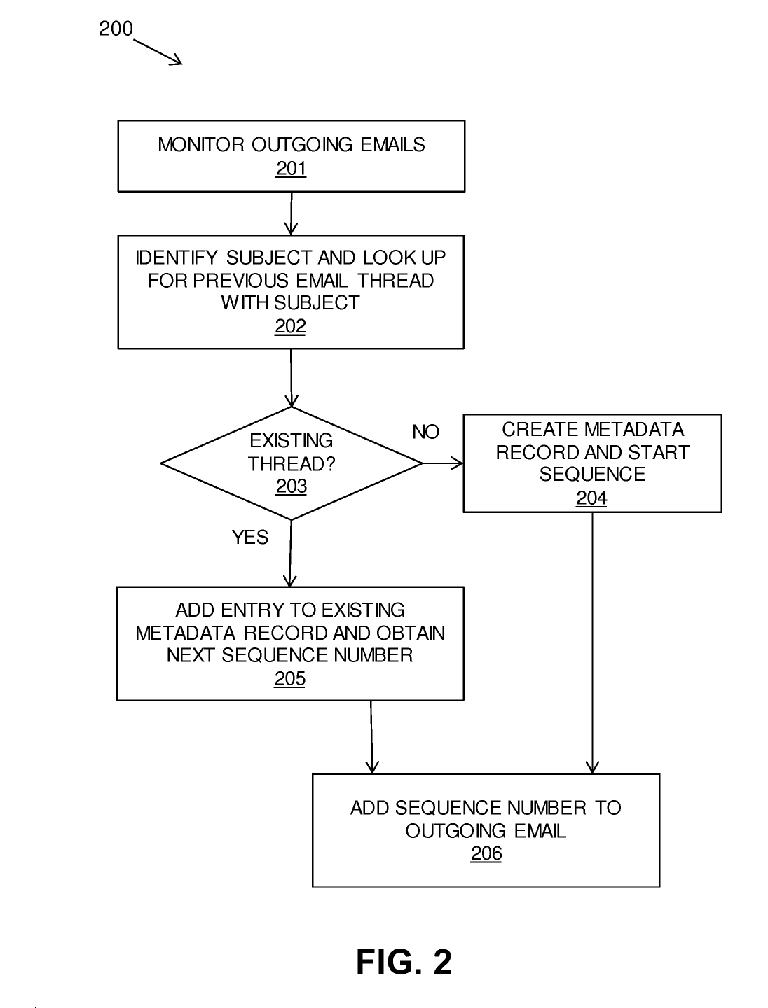

FIG. 2 depicts a flow diagram 200 for a sequence management system, according to various embodiments.

The sequence management system may be integrated into an email server, according to various embodiments.

Outgoing emails may be monitored 201. A subject of an outgoing email may be identified and looked up 202 in the recorded metadata table to see if the outgoing email relates to an existing email thread with this subject. It is determined 203 if there is an existing email thread, according to various embodiments.

If there is no existing email thread for the subject, then a metadata record is created 204 and a sequence started. The first sequence number is assigned as 1 and added 206 to the outgoing email message.

If there is an existing email thread for a subject, it may be checked if the sender and recipients are overlapping with the existing sender and recipients in the existing messages. If they are, the metadata record is retrieved and an entry is added for the current message 205, including incrementing the sequence number by 1, according to various embodiments. The sequence number is added 206 to the outgoing email message. If the sender and recipients are not overlapping, then step 204 is carried out to create a new metadata record.

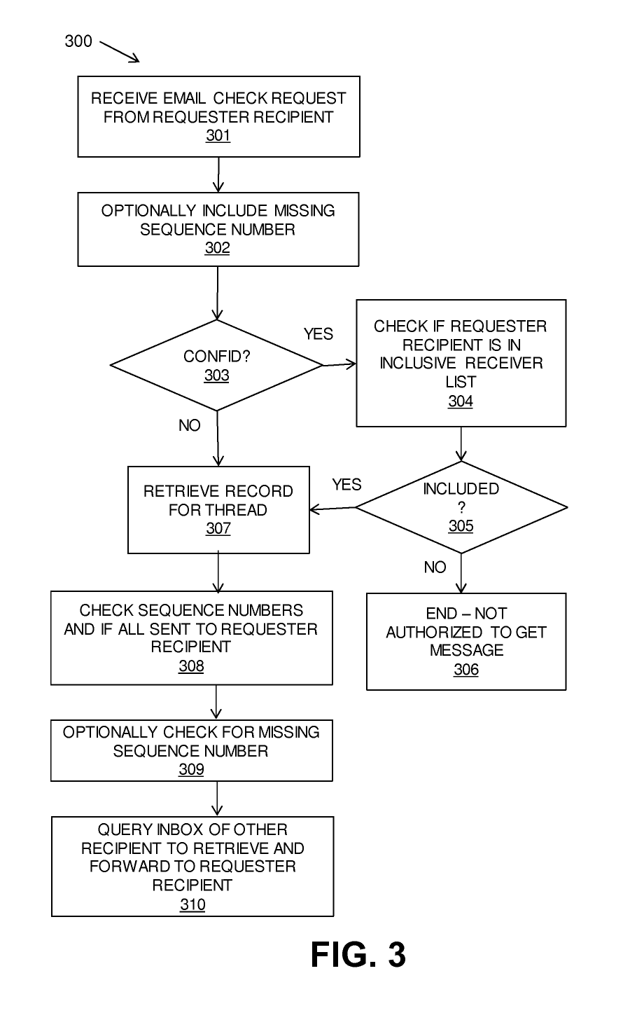

FIG. 3 depicts a flow diagram 300, which illustrates a method carried out by the sequence management system, according to various embodiments.

The sequence management system may be integrated into an email server, according to various embodiments.

This embodiment illustrates the response to a missing email request from a recipient.

An email check request may be received 301 from a requester recipient. The check request may identify the email thread by the subject. The request may optionally include 302 a missing sequence number or may request any missing emails from a thread.

The query system may check if this requester's email name address is included in the history of sender and recipients. If it is, then the query system will retrieve and send the missing email; if not, then a message may be sent back indicating that the requesters has no missing emails with this subject.

It may be that an email thread becomes confidential part way through the conversation and this may exclude some of the original recipients. An inclusive receiver list is then generated and stored listing the authorized recipients which may be included in the metadata table. As an optional step, the method may determine 303 if the email thread is marked as confidential. If it is marked as confidential, the method may check 304 if the requester recipient is included in an inclusive receiver list. If it is determined 305, that the requester receiver is not included in an inclusive receiver list, then the requester receiver is not authorized to receive the requested email message and the method may end 306 with a notification being sent to the requester.

If the requester recipient is included in the inclusive receiver list or the message is not confidential, then the method proceeds to retrieve 307 the metadata record for the email thread, according to various embodiments.

At 308, the sequence numbers of the record may be checked and it may be ascertained if all messages have been sent to the requester recipient. This may be accomplished by applying a filter on the record for recipients. Optionally, the method may include checking 309 for a specific sequence number as requested at step 302.

If there are one or more missing email messages to be sent to the requester recipient, the method may query 310 the inbox of a different recipient, or the sent item box of the sender of the message, and may forward the missing message or messages to the requester recipient. The query 310 may include various forms of checking, parsing, analyzing, etc. The query may communicate with various components, as described herein, among others.

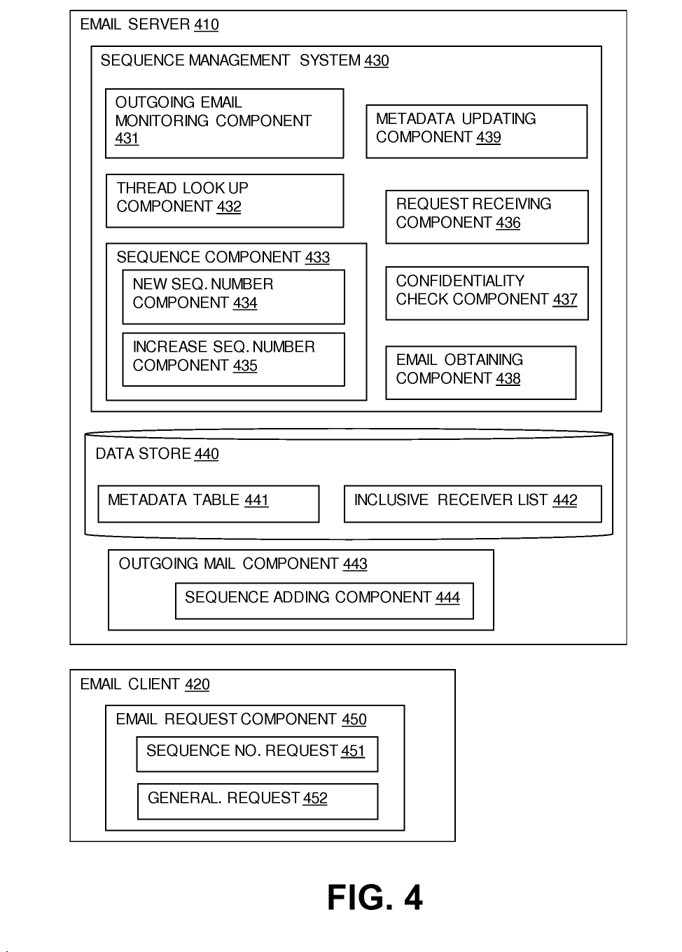

FIG. 4 depicts a block diagram shows an email server 410 and email client 420, according to various embodiments.

The email server 410 may include a sequence management system 430. The sequence management system 430 may be integrated into an existing email server 410. In one embodiment, the sequence management system 430 may be deployed in the cloud and plugged into an existing email server. The email server 410 may be integrated with the sequence management system via application programming interfaces (APIs).

The sequence management system 430 populates a metadata table 441 in a data store 440 which may be local to the email server 410 or provided remotely. An inclusive receiver list 442 may also be stored for confidential emails wherein the list of authorized recipients of email in a confidential email thread may be stored. The inclusive receiver list 442 may include a list of any relevant receivers, including requesting receivers, according to various embodiments. The inclusive receiver list 442 may change, as necessary, according to various embodiments.

The sequence management system 430 may include an outgoing mail monitoring component 431 for monitoring an outgoing mail component 443, which sends email messages from the email server 410. The outgoing mail monitoring component 431 may identify a subject of an outgoing email and a thread look up component 432 may determine if a record in the metadata table 441 exists for this thread.

A metadata updating component 439 may create a new record in the metadata table 441 for a new email thread, or may update an existing record for an email thread with a new entry for the new email message.

A sequence component 433 may include a new sequence number component 434 for allocating a first sequence number for a new record created for a new email thread. The sequence component 433 may also include an increase sequence number component 435 for increasing a sequence number for a new message in an existing email thread. The sequence component 433 may add the sequence number to the outgoing email message using the sequence adding component 444 provided in the outgoing mail component 443 of the email server 410.

An email client 420 may include an email request component 450 for requesting one or more missing emails from an email thread. This may be integrated into the email client 420 as a request button associated with an email thread. A sequence number request 451 may include a sequence number of a missing email. A general request 452 may prompt a check for any missing emails at a client for a thread.

A request receiving component 436 may be provided at the sequence management system 430 which may retrieve a record for the email thread from the metadata table 441 and determine if there are missing email messages for the requester. A confidentiality check component 437 may check if the email thread is confidential and, if so, may check if the requester recipient is listed in the authorized inclusive receiver list 442 for the thread. An email obtaining component 438 may retrieve a missing email from an inbox of the email server 410 of a recipient who did receive the email message or from a sent messages box of the sender of the missing message. The missing message may then be forwarded by the email obtaining component 438 to the requester recipient.

The described method and system use a metadata management to identify missing email and query the missing email from other individuals for the missing participants, according to various embodiments. The full sequence information for an email thread may be stored separately.

Users who take part in a chain of email exchanges, may need to be able to obtain missing parts of the chain either because they join late or they get missed out of the copy list on some replies. The described method and system solves the problem by finding the missing emails from other user's inboxes rather than keeping a central database of all messages.

A recipient can press a button to query a missing email with the sequence number when he/she find out there is a missing email in the chain. The system then checks who has this email and queries the email from that person's mail box, and sends it to the requester.

A recipient may also request missing email numbers, if these are not known, for example, if they are after the received sequence numbers. The request may look up the metadata record for the email thread and filter for the recipient to find missing sequence numbers and may respond to the requester recipient with the missing numbers or may indicate that there are no missing email messages for the subject.

The system may be modified to identify that a recipient has been missed from an email message in an email thread, and to retrieve and forward the email to the missing recipient. However, it is envisaged that the method wait for a request from the recipient to avoid unnecessary forwarding of email messages which do not apply to a missed recipient. In some cases, recipients are deliberately deleted by senders.

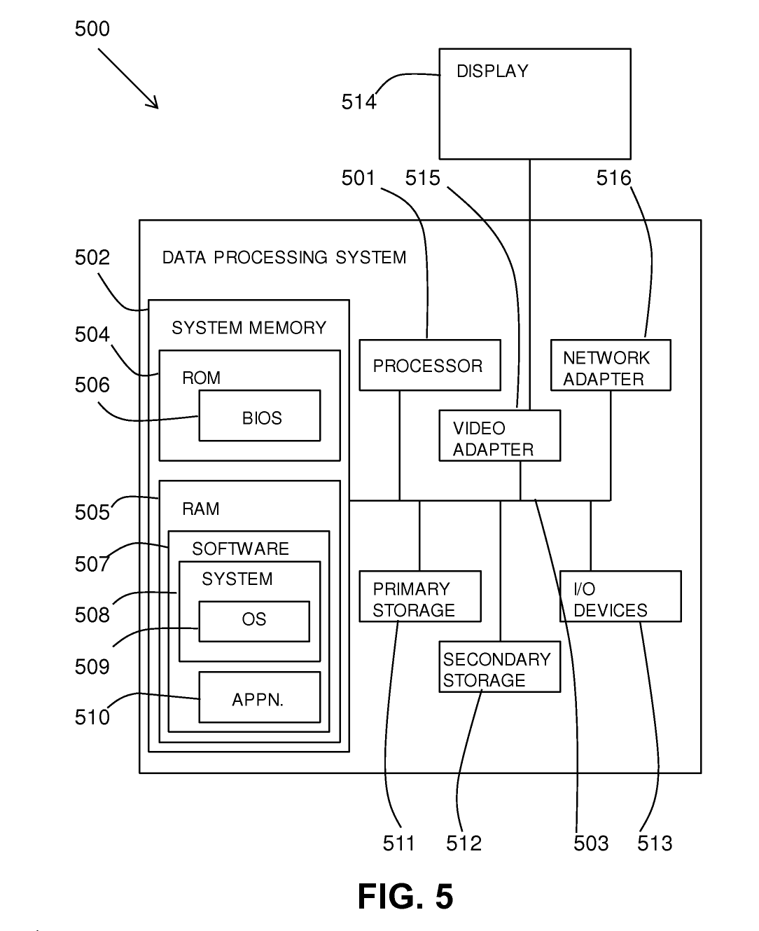

FIG. 5 depicts an exemplary system, as described herein, according to various embodiments.

The system may include a data processing system 500 suitable for storing and/or executing program code including at least one processor 501 coupled directly or indirectly to memory elements through a system bus 503. The memory elements may include local memory employed during actual execution of the program code, bulk storage, and cache memories which provide temporary storage of at least some program code in order to reduce the number of times code must be retrieved from bulk storage during execution.

The memory elements may include system memory 502 in the form of read-only memory (ROM) 504 and random access memory (RAM) 505. A basic input/output system (e.g., a BIOS) 506 may be stored in ROM 504. Software 507 may be stored in RAM 505 including system software 508 such as operating system software 509. Software applications 510 may also be stored in RAM 505.

The system 500 may also include a primary storage means 511 such as a magnetic hard disk drive and secondary storage means 512 such as a magnetic disc drive and an optical disc drive. The drives and their associated computer-readable media provide non-volatile storage of computer-executable instructions, data structures, program modules and other data for the system 500. Software applications may be stored on the primary and secondary storage means 511, 512 as well as the system memory 502.

The system 500 may operate in a networked environment using logical connections to one or more remote computers via a network adapter 516.

Input/output devices 513 may be coupled to the system either directly or through intervening I/O controllers. A user may enter commands and information into the system 500 through input devices such as a keyboard, pointing device, or other input devices (for example, microphone, joy stick, game pad, satellite dish, scanner, or the like). Output devices may include speakers, printers, etc. A display device 514 is also connected to system bus 503 via an interface, such as video adapter 515.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for email thread sequence management, comprising:
monitoring outgoing email messages of an email server;
creating a metadata record for an email thread of multiple email messages relating to a subject, wherein the metadata record includes an entry of metadata for each email message in the email thread, and wherein each entry has a sequence number;
adding a sequence number to an outgoing email message according to the sequence number of the email message in the metadata record for the email thread;
receiving, from a requesting recipient, a request for a missing email message in the email thread;
checking the metadata record for the email thread for the missing email message from the requesting recipient; and
retrieving the missing email message from a different recipient or the sender of the email message for forwarding to the requesting recipient.

2. The method of claim 1, wherein receiving the request for the missing email message in the email thread from the requesting recipient includes identifying the subject of the email message and retrieving the metadata record for the email thread relating to the subject.

3. The method of claim 1, wherein the metadata record entry for the email message includes: a sequence number of the email message in the email thread, a send date and time, a subject, and the parties to the email message.

4. The method of claim 1, wherein receiving the request for the missing email message includes a sequence number for the missing email message for use in checking the metadata record.

5. The method of claim 1, wherein receiving the request for the missing email message includes:
checking and querying all missing email messages in the email thread for the requesting recipient.

6. The method of claim 1, further comprising:
determining that the email thread is confidential and verifying that the requesting recipient is an authorized participant in the email thread.

7. The method of claim 6, wherein verifying that the requesting recipient is the authorized participant includes checking an inclusive receiver list maintained for the email thread listing authorized participants.

8. A system for email thread sequence management comprising a sequence management system integrated with an email server, wherein the sequence management system includes:
an outgoing email monitoring component for monitoring outgoing email messages of an email server;
a metadata updating component for creating a metadata record for an email thread of multiple email messages relating to a subject, wherein the metadata record includes an entry of metadata for each email message in the email thread, and wherein each entry has a sequence number;
a sequence component for adding a sequence number to an outgoing email message according to the sequence number of the email message in the metadata record for the email thread;
a request receiving component for receiving, from a requesting recipient, a request for a missing email message in the email thread; and
an email obtaining component for checking the metadata record for email thread for the missing email message from the requesting recipient retrieving the missing email message from a different recipient or the sender of the email message for forwarding to the requesting recipient.

9. The system of claim 8, wherein the request receiving component for receiving the request for the missing email message in the email thread from the requesting recipient includes identifying the subject of the email message and retrieving the metadata record for the email thread relating to the subject.

10. The system of claim 8, wherein the metadata record entry for the email message includes: a sequence number of the email message in the email thread, a send date and time, a subject, and the parties to the email message.

11. The system of claim 8, wherein the request receiving component for receiving the request for the missing email message includes receiving a sequence number for the missing email message for use in checking the metadata record.

12. The system of claim 8, wherein the request receiving component for receiving the request for the missing email message checks and queries all missing email messages in the email thread for the requesting recipient.

13. The system of claim 8, further comprising:
a confidentiality check component for determining if the email thread is confidential and, if so, verifying that the requesting recipient is an authorized participant in the email thread.

14. The system of claim 13, further comprising an inclusive receiver list maintained for the email thread listing authorized participants.

15. A computer program product for email thread sequence management, the computer program product comprising a computer readable storage medium having program instructions embodied therewith, the program instructions executable by a processor to cause the processor to:
monitor outgoing email messages of an email server;
create a metadata record for an email thread of multiple email messages relating to a subject, wherein the metadata record includes an entry of metadata for each email message in the email thread, and wherein each entry has a sequence number;
add a sequence number to an outgoing email message according to the sequence number of the email message in the metadata record for the email thread;
receive, from a requesting recipient, a request for a missing email message in the email thread;
check the metadata record for the email thread for the missing email message from the requesting recipient; and
retrieve the missing email message from a different recipient or the sender of the email message for forwarding to the requesting recipient.

16. The computer program product of claim 15, wherein receive the request for the missing email message in the email thread from the requesting recipient includes identifying the subject of the email message and retrieving the metadata record for the email thread relating to the subject.

17. The computer program product of claim 15, wherein the metadata record for the email thread of multiple email messages includes: a sequence number of the email message in the email thread, a send date and time, a subject, and the parties to the email message.

18. The computer program product of claim 15, wherein receive the request for the missing email message includes receiving a sequence number for the missing email message for use in checking the metadata record.

19. The computer program product of claim 15, wherein receive the request for the missing email message includes checking and querying all missing email messages in the email thread for the requesting recipient.

20. The computer program product of claim 15, wherein the program instructions executable by the processor further to cause the processor to:
determine that the email thread is confidential and, verifying that the requesting recipient is an authorized participant in the email thread, wherein verifying that the requesting recipient is the authorized participant includes checking an inclusive receiver list maintained for the email thread listing authorized participants.
